(19) United States
(12) Patent Application Publication
(10) Pub. No.: US 2004/0049523 A1
(43) Pub. Date: Mar. 11, 2004

(54) Recallable business card organizer

(76) Inventor: Pavel Macholda, West Linn, OR (US)

Correspondence Address: Pavel Macholda, Suite 200, 1800 Blankenship Road, West Linn, OR, 97068, US

(21) Appl. No.: 10/237,282

(22) Filed: Sep. 9, 2002

(51) Int. Cl. G06F 12/00; G06F 17/30

(52) U.S. Cl. 707/201; 707/10

(57) ABSTRACT

The Recallable Business Card Organizer is a device capable of storing contact information derived from regular or electronic business cards and identifying the original owner of the business card by locating his Organizer using the unique contact information contained in the business card. The original business card owner can then ‘recall’ the business card and change its contents at a later date.

### BACKGROUND OF THE INVENTION

1. Field of the Invention

The invention relates to the field of applications for communication devices capable of storing and processing information in a digital form, such as cellular phones, wireless personal digital assistants, network appliances and computers. The closest U.S. patent Classification Definition is described in Class 707, Subclass 104—application of distributed data structure to commercial fields.

2. Background Information

Daily, millions of people give out business cards or send their contact information electronically. Once they part with that information, they cannot control it anymore and when they change their phone number or e-mail address, they have to start all over again, contacting all the people, whom the deem important, to give them the new contact information. And yet, there is a well developed network of computers, cell-phones and other wireless devices, perfectly capable of keeping track of electronic business cards and changing the contact information the cards contain in real-time.

### BRIEF SUMMARY OF THE INVENTION

A business card may contain contact information either in printed or electronic form. The recipient files the business card in the Recallable Business Card Organizer, which is a device consisting of software, hardware, or both, capable of communicating with other Recallable Business Card Organizers, for instance, using the Internet or other forms of wire or wireless communication. The recipient's device locates the device of the business card owner and registers the business card, now inside the recipient's device, with the device of the business card owner. The recipient's device is capable of locating the owner's device because each business card contains information uniquely identifying the owner, for instance, an e-mail address or phone number. Thus, the system automatically establishes a live connection between the two users and can synchronize the contact information of both users. The system allows a new user to join at any time, and the device automatically processes the contact information that the new user enters. The system also periodically processes the contact information kept in the device and for which the device previously had not found an owner. Thus, the device is capable of locating new users as they join the system at a later time. The process of locating the other users is made completely transparent to the user of the device, except for the notifications when the connection is established.

### DRAWINGS

### Brief Description of the Drawings

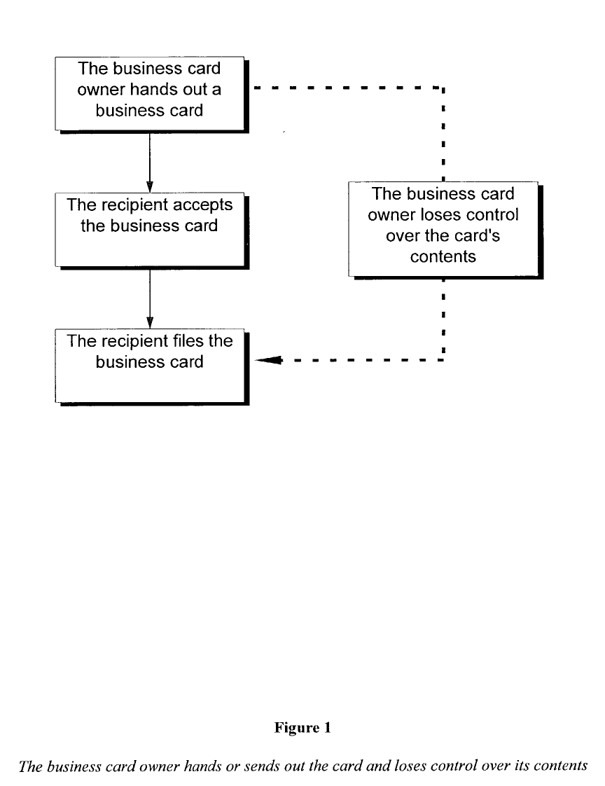

FIG. 1

The business card owner hands or sends out the card and loses control over its contents. Presently, when a person gives or sends out a business card in either paper or electronic form, the person loses control over the information as soon as the card reaches the recipient. The person then has to contact the recipient again, providing it is possible, and update the contact information whenever there is a change.

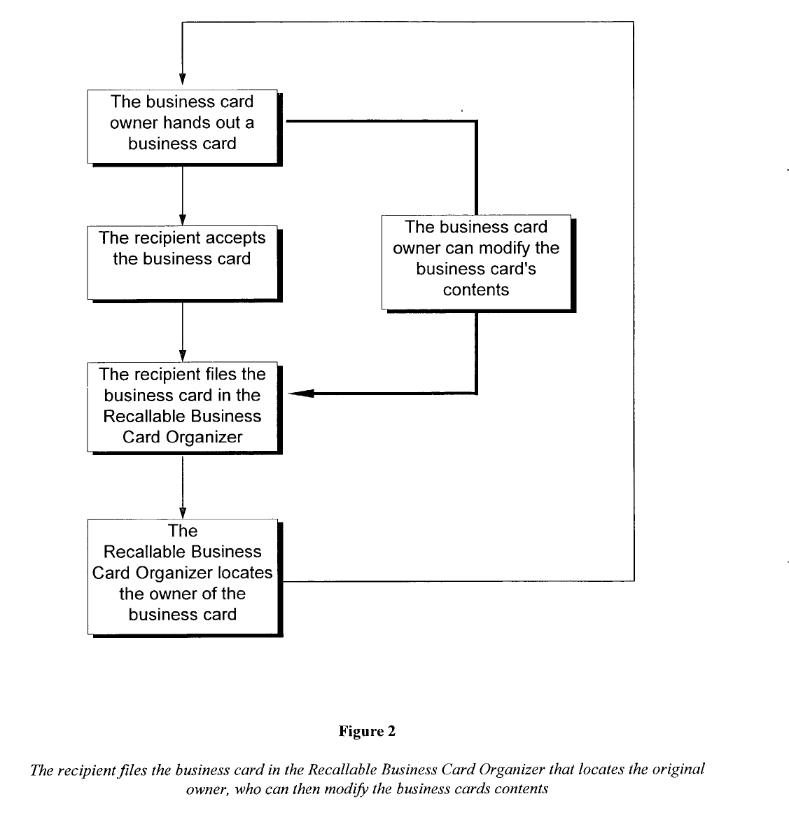

FIG. 2

The recipient files the business card in the Recallable Business Card Organizer that locates the original owner, who can then modify the business cards contents. The Organizer uses the information contained in the business card to identify the owner of the business card and establish a link between the two users. Then, the business card owner can change the contents of the business card after it has been handed or sent out. Thus, whenever the business card owner changes his contact information, the system updates the information in the recipient's Organizer.

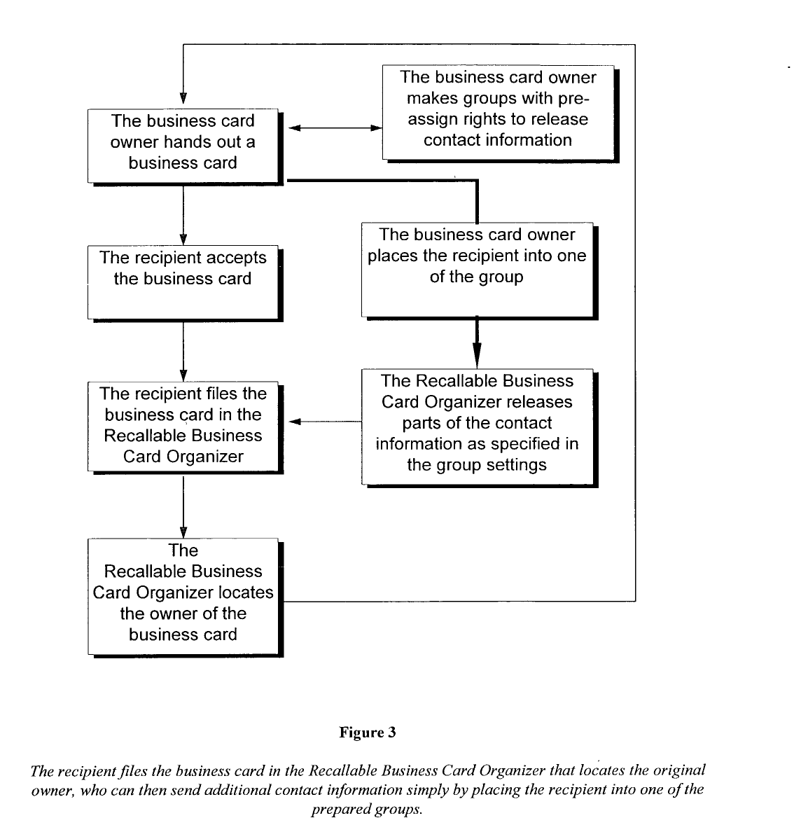

FIG. 3

The recipient files the business card in the Recallable Business Card Organizer that locates the original owner, who can then send additional contact information simply by placing the recipient into one of the prepared groups. The business card owner may want to supply additional contact information, that is not included in the business card, to a selected number of individuals. In order to simplify the choices of who is allowed to receive what parts of the additional contact information, the card owner creates groups with pre-assigned rights to receive selected parts of the additional contact information. When the card owner is notified by the system that his card has been included in someone's Organizer (or any time later), the card owner can simply place such a recipient into one of the pre-arranged groups and the owner's Organizer sends the allowed additional information to the Organizer of the recipient.

### DETAILED DESCRIPTION

A business card may consist of either a printed piece of paper or plastic, or digital media, such as a CD, or an electronic packet of data, such as a virtual business card that is often attached to e-mails. All of these forms of a business card have one thing in common: once the owner gives or sends them to another person, the owner loses control over the information that the card contains. The Recallable Business Card Organizer allows the business card owner to modify his contact information at any later date, even after he has parted with the business card. The Recallable Business Card Organizer does not need to displace the present forms of business cards, but rather can bring an order to the way these business cards are kept and filed. For instance, it would be hard to imagine trying to change the print on a paper business card but, eventually, the recipient might copy the information from the card into a computer or electronic organizer. It is at this moment, when the information changes form, that it is possible to locate the person who handed out such a business card, as each business card contains some information that uniquely identifies its owner. Then, an electronic connection can be established between the Organizers of both users and the system can continually synchronize their contact information. Thus, for instance, a salesperson who switches to another agency can change his contact information on many business cards that would otherwise be invalid. In another example, an agency might want to own the business card information and change the name and e-mail address of the salesperson when a new person becomes in charge of a group of potential clients.

The main advantage of the Recallable Business Card Organizer rests in the way the users join the system. The method does not require any change in the present system of exchanging business cards, either physically or electronically, and any new user can join the system at any time. The Organizer of such a new user automatically connects the user with the system and continually scans the system to establish new live connections.

A business card owner gives or sends out his business card to a recipient who has several choices: a) to keep the business card as is, without filing it anywhere, or entering the card information into a standard contact organizer; thus the present widely used system of giving or sending business cards is not affected; b) to file the business card into the Recallable Business Card Organizer and allow the card's modification at the later date by the business card owner; c) do the steps under the later option plus allowing the system to send his own electronic business card automatically back to the original business card owner, who might or might not meanwhile have filed the recipient's business card into his own Recallable Business Card Organizer.

Of course, if either person, or neither one, has a Recallable Business Card Organizer, the present form of giving or sending business cards is not affected. Whenever a person chooses to implement a Recallable Business Card Organizer for his contact management needs, the device allows the new user to enter all the contact information that the user has in either printed form, by allowing him to type in or scan the business cards, or electronic form, by allowing him to import the contact information from a variety of popular contact management systems and formats. As the new user adds the information, the Recallable Business Card Organizer tries to locate the Recallable Business Card Organizer of the person whose contact information the new user is adding. If the system finds such an Organizer, the two devices establish a connection, according to the options selected by the owners of each device, for instance, the new user may allow his device to dispatch his electronic business card to the device of the found user. In the Organizer, the contact information is clearly identified as either a standard or live contact information.

The standard information remains in the shape and form as the user enters it into the Organizer, as the device could not locate the owner of the business card. The Organizer periodically searches for the business card owner, in case such a person joins the system at a later date. Each Organizer periodically verifies the accuracy of the live contact information by locating the device of owner of the business card and synchronizing the contents in the Organizer with the information provided by that user. Also, each user can use his device to scan the network and release the location information about where his contact information resides, together with the contact information of the owner of each device, providing such an owner consented, through setting the options in his device, to release his contact information.

Each user of the Recallable Business Card Organizer can add his personal contact information in addition to his business card information. Then, the personal contact information, such as the home address or phone number, is made available only to those other people whom the user individually identifies. In order to simplify the release or denial of certain parts of the personal contact information, the user can create named groups, for instance, ‘friends’ or ‘family’. For each group, the user decides what parts of his private contact information he wants to make available, for instance, home phone and address for ‘friends’, and home phone number, address, and cell-phone for ‘family’. Then, the user can review the list of all the people who can access his contact information and, by placing each person into one or more groups, authorize the system to release or deny his private contact information to the selected person. Optionally, the user can individually select what parts of his contact information can other people see, piece by piece on a person by person basis.

What is claimed is:

1. A business card organizer that can locate the original owner of each business card listed in the organizer, where the owner is identified by the information contained in the business card and is a user of the system.

2. A business card organizer that can locate all the other business card organizers that include the contact information of the owner of the former business card organizer.

3. A business card organizer set forth in claim 1. that is capable of refreshing the contents of a business card kept in the organizer with new content whenever the original owner of the business card changes his contact information.

4. A business card organizer set forth in claim 2. that is capable of updating the contents of the organizer owner's business card kept in the organizers of other users with new content whenever the former organizer's owner changes his contact information.

5. A business card organizer set forth in claims 1. and 2. that can selectively release or deny parts of the owner's contact information for the purpose of refreshing the contents of other organizers, based on the selections made by the business card organizer owner.

6. A business card organizer set forth in claims 1. and 2. where the user can preemptively create group names and assign rights to release or deny particular pieces of the contact information to each group.

7. A business card organizer set forth in claims 1. and 2. where the user can place each listed name into one or more groups, thus denying or releasing the particular pieces of the contact information based on the rights assigned to each group.

8. A business card organizer set forth in claims 1. and 2. that is capable of updating non-textual entities, such as graphics, images, photographs, video and audio content pertaining to a particular business card.

9. A business card organizer set forth in claims 1. and 2. that is capable of sending the owner's electronic business card automatically to another user who is uniquely identified by the contact information contained in the business card and who consents to receiving automatically electronic business cards, where the electronic business card contains the contact information released according to the owner pre-defined or group settings.
